(19) United States
(12) Patent Application Publication
(10) Pub. No.: US 2008/0140654 A1
(43) Pub. Date: Jun. 12, 2008

(54) PROJECT SCHEDULE ANALYZER

(75) Inventor: JAMES D. DALEY, CORAL GABLES, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/609,736

(22) Filed: Dec. 12, 2006

(51) Int. Cl. G06F 17/30; G06F 7/00

(52) U.S. Cl. 707/6; 707/102; 707/E17.005; 707/E17.045

(57) ABSTRACT

A system for analyzing the current status of a project including a project schedule (110) representing activity information associated with project activities stored as a relational database, including requirements associated with each project activities and one or more dependencies interrelating at least two project activities; a database interface (130) to allow access to the relational database; and an analyzer (120) to analyze selected critical paths, where a series of interrelated project activities terminating with a critical activity defines a critical path. The system operating by the analyzer (120) accessing the relational database using the database interface (130), searching the relational database for one or more data structures associated with the one or more selected critical paths, retrieving the data structures associated with the selected critical paths, analyzing the data structures, and outputting a result of the analysis to a user interface (121).

### FIELD

This invention relates generally to project management, and more particularly to systems and methods for analyzing large, complex project schedules.

### BACKGROUND

Ever increasingly, the development of advanced products has become more complex. Many products now require product development times that can exceed a year and are dependent on a large number of interrelated tasks being completed. Therefore, many companies presently create very large, complex, cross-functional schedules to track the development of new products. Because of the long timetables involved and the negative business impact of missing promised delivery dates, product development managers currently use software-based project scheduling applications, such as Microsoft Project™, to accurately create and manage very detailed project schedules. However, such applications only provide limited capabilities to analyze a project schedule and determine the overall status and progress of the project.

Generally, in order for a project manager to establish a schedule baseline and commit to a delivery date, a project manager or any other reviewer is required to manually make a detailed examination of the project schedule, even with modern electronic project scheduling systems. During this examination, the reviewer must to go through the schedule carefully, examining the schedule for completeness, accuracy, reliability, and realism. Typically, the development, troubleshooting, and review process of such complex and detailed schedules is a lengthy and tedious manual process of checking constraints, task linkages, and mapping the project's one or more critical paths. Even after the one or more critical paths have been found, it is still necessary to go back and evaluate each path and run multiple tests in order to collect various metrics that can allow project managers to determine the overall status of the project.

Existing applications for analysis of complex schedules are typically limited in functionality. First, most of these applications provide only a limited number of functions or filters to extract and examine critical path information associated with a project schedule. Furthermore, the ability to use and combine such functions is generally limited. For example, Microsoft Project™ can only present one filter at a given time, therefore each time a user needs to change a filter, the filter parameters must be reentered. Additionally, most applications do not allow filter results to be stored for future analysis. Therefore, despite the availability of filters and functions in existing applications, their use is generally cumbersome and requires significant expertise on the part of the reviewer to correctly program the proper filters to achieve a desired result.

Because of this high level of expertise required to properly use filters to manipulate project schedule data, there is an increased probability of using filters inconsistently. Inconsistent filter use is particularly undesirable for a company developing several products simultaneously, since the status of the multiple projects cannot be evaluated in a consistent manner. Even worse, a single project may be evaluated differently at two points in time, providing results that cannot be meaningfully compared. Modern business practices call for consistent and standardized evaluation of projects, since the success of modern businesses often hinges on determination of which projects should be completed or abandoned.

Furthermore, existing systems do not generally provide organized, comprehensive, or intelligible reporting of the evaluation results. In general, the results obtained from an analysis are complicated and are not provided to a reviewer in a way that can be easily communicated or forwarded to others interested in the results of the evaluation. This is particularly problematic when creating and presenting project proposals to supervisors or investors, as such individuals generally may not understand the underlying technical details of the project, yet still must make a decision based on the probability of success of the various tasks and activities required for a project to be completed on budget and on time.

A project schedule analysis system fails to exist that provides for an automated method to extract information from large, complex project schedules and that further simplifies the analysis process by allowing any reviewer to determine the status of a project at any time, while not requiring any type of training on the part of the reviewer. Furthermore, no known analyzer provides for consistent evaluation of project schedules, allowing for consistent evaluation between various product lines and during various points in the development of a single project to allow for meaningful comparisons.

### SUMMARY OF THE INVENTION

Embodiments in accordance with the present invention provide for an analysis system and methods that provide for the automated access, retrieval, manipulation, and analysis of a database representing a project schedule and reporting of the results obtained in a summary or comprehensive fashion.

In a first embodiment, a system for analyzing the current status of a project, the system can include a project schedule consisting of data structures representing activity information associated with a plurality of project activities stored in a relational database, where the activity information represents one or more requirements associated with each one of the plurality of project activities and one or more dependencies interrelating at least two of the plurality of project activities. The system can also include a database interface configured to allow access to at least a portion of the data structures stored in the relational database and an analyzer configured to perform an analysis of selected critical paths, where the critical paths are selected according to some criteria, and where a series of interrelated project activities terminating with a critical activity define a critical path. In operation, the analyzer accesses the relational database using the database interface, searches the relational database for one or more data structures associated with the one or more selected critical paths, retrieves the one or more data structures associated with the one or more selected critical paths, analyzes the one or more one data structures associated with the one or more selected critical paths, and outputs a result of the analysis to a user interface. The system can also be further configured to analyze the project schedule according to one or more subtests and report the result of each subtest to the user interface in a summary or comprehensive fashion. Each of these subtests can be further configured to analyze identified critical paths. Furthermore, at least one of these subtests can be further configured to perform standardized tests on the project schedule.

In a second embodiment of the invention, a method for analyzing the current status of a project can include the steps of locating a project schedule consisting of data structures representing activity information associated with project activities stored in a relational database (where the activity information consists of requirements associated with each project activity and dependencies interrelating project activities), accessing the relational database using a database interface (where the database interface is configured to allow access to at least a portion of the data structures stored in the relational database), searching the relational database for data structures associated with the selected critical paths (where each selected critical paths consists of a critical path selected according to some criteria and where a series of interrelated project activities terminating with a critical activity defines a critical path), retrieving the data structures associated with the selected critical paths, analyzing the data structures associated with the selected critical paths, and outputting results of the analysis of the data structures to a user interface. The method can also include analysis of the project schedule according to one or more subtests and reporting the result of each subtest to the user interface in a summary or comprehensive fashion. Each of these subtests can be further configured to analyze identified critical paths. Furthermore, at least one of these subtests can be further configured to perform standardized tests on the project schedule.

A third embodiment of the present invention consists of a machine readable storage storing a computer program having code sections executable by a machine for causing a machine to perform the steps of storing a relational database (where the relational database stores data structures representing activity information associated with a plurality of project activities and where the activity information includes requirements associated with each project activity and dependencies interrelating project activities), retrieving a project status instruction set (where the project status instruction set includes instructions for an analysis of selected critical paths, where each selected critical paths consists of a critical path selected according to some criteria defined in the project status instruction set and where a series of interrelated project activities terminating with a critical activity defines a critical path), accessing the relational database using a database driver (where the database driver provides access to the data structures stored in the relational database), searching the relational database for data structures associated with the selected critical paths, retrieving the data structures associated with the selected critical paths, analyzing the data structures associated with the selected critical paths according to the project status instruction set, and outputting a result of the analysis of the data structures associated with the selected critical paths to a user interface. The computer program can also include code sections causing a machine to perform an analysis of the project schedule according to one or more subtests and report the result of each subtest to the user interface in a summary or comprehensive fashion. Each of these subtests can be further configured to analyze identified critical paths. Furthermore, at least one of these subtests can be further configured to perform a standardized test on the project schedule.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. A project schedule can be any schedule or timeline for completing a task, project, product, service, activity or job. A project activity can by any activity associated with a task, project, product, or job. A data structure can be any activity information associated a plurality of project activities stored in a relational database. Activity information can include one or more requirements associated with the project activity or activities. A database interface can be any interface enabling access to at least a portion of the data structures stored in the relational database. A relational database is a collection of data items organized as a set of formally-described tables (or other data structures) from which data can be accessed or reassembled in many different ways. An analyzer as contemplated herein performs an analysis of one or more selected critical paths. A critical path can be a series of interrelated project activities having or terminating with a critical activity or activity of great importance for the project. The word “exemplary” is used herein to mean “serving as an example, instance, or illustration.” Any embodiment or design described herein as “exemplary” is not necessarily to be construed as preferred or advantageous over other embodiments or designs.

### BRIEF DESCRIPTION OF THE DRAWINGS

FIG. 1 is an exemplary diagram of the elements of a project schedule analysis system in accordance with an embodiment of the invention.

FIG. 2 is an exemplary general flow for analysis of a project schedule in accordance with an embodiment of the invention.

FIG. 3 is an exemplary flow for an analysis tool analyzing a project schedule in accordance with an embodiment of the invention.

FIG. 4 is a screenshot of a summary report for an analysis of a project schedule in accordance with an embodiment of the invention.

FIG. 5 is a screenshot of a subtest result for an analysis of a project schedule in accordance with an embodiment of the invention.

### DETAILED DESCRIPTION OF THE DRAWINGS

With reference to the various figures in which like elements are identically numbered throughout, a description of the various embodiments of the present invention will now be provided. While the invention is disclosed in the context of a single arrangement, it can be appreciated that the invention can include numerous modifications from the presented embodiments.

Embodiments in accordance with the invention can provide a solution for enabling one or more reviewers to access and consistently analyze large, complex project schedules in a consistent manner at any time without requiring any specialized analysis training on the part of a reviewer. In general, a typical project schedule is constructed using a scheduling application in which one or more users can input a plurality of project activities which define or describe events required for successful project completion. Furthermore, one or more requirements or dependencies, which define or describe events required for successful project activity completion, may be associated with each project activity. In accordance with one embodiment, once a project schedule is completed, the reviewer can use an analysis tool configured to access, retrieve, manipulate, and analyze the schedule. The invention further allows the analysis tool to report the results in a simplified and manageable format.

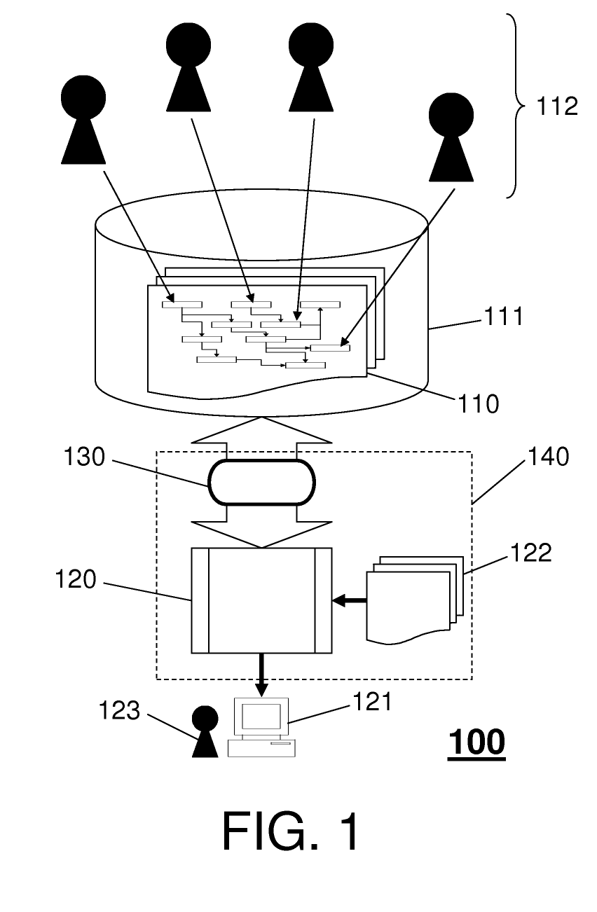

FIG. 1 illustrates an exemplary system 100 in accordance with the present invention. As illustrated, the exemplary system 100 includes a project schedule 1 10, an analysis application or module 120, and a database interface 130. In the exemplary system 100, one or more project schedules 110 are stored in a mass storage system 111. The mass storage system 111 may comprise a local or remote mass storage system. In the various embodiments, access to the project schedule 110 may also be provided to one or more users 112, allowing at least one of the users 112 to modify or update a project schedule 110 as additional project activities are defined and modified or as project activities are completed. In embodiments where the mass storage system 111 is accessed remotely by the users 112, it can be appreciated that such access may be provided locally, or through a network connection, wired or wirelessly, using personal digital assistants, laptop computers, desktop computers, smart phones, or essentially any computing device capable of receiving and displaying data. Furthermore, in the exemplary system, access is provided via a scheduling application or module, such as Microsoft Project™. In the various embodiments, the scheduling application or module comprises a computer program configured to allow one or more users 112 to construct and modify one or more project schedule 110s.

In the various embodiments, a project schedule 110 is constructed using a scheduling application or module by defining one or more project activities required for project completion, one or more requirements needed for a project activity to be completed, and one or more dependencies for a project activity to be commenced or completed. In the various embodiments, the project activities, requirements, and dependencies are stored by the scheduling module as entries in a relational database. A relational database allows for efficient storage, access, and modification of the project schedule 110, by storing the project schedule 110 as a number of related tables sharing at least one field.

In the various embodiments, an analysis module 120 will typically comprise a processor or application specifically designed for the manipulation and analysis of large amounts of data. One example is a spreadsheet program, such as Microsoft Excel™. In the various embodiments, use of a spreadsheet application is advantageous in that spreadsheet applications are widely deployed in most businesses and require only minimal expertise to use. However the invention is not limited in this regard and the analysis module could comprise any application designed to manipulate and analyze a set of data in a tabular form. In the various embodiments, use of such applications is advantageous because such applications allow complex formulas, complex data manipulation methods, and even the result of an analysis to be stored for later use or review in a file. In addition, because the relational database representing the project schedule 110 is normally stored as a series of tables, such applications can be easily configured to perform the tedious and repetitious steps required for performing relational operations in order to filter and analyze the project schedule 110.

It can be appreciated that in some embodiments, the analysis module 120 can be configured to operate using a separate instruction set 122. In such embodiments, the instruction set 122 can include analysis methods, activities, requirements, or dependencies to be analyzed, or even the location of the project schedule 110 to be analyzed. Such embodiments are advantageous in that the instruction sets can be customized depending on the reviewer 123 without affecting the basic functionality of the analysis module 120. However, it can also be appreciated that in some embodiments the instruction set 122 and the analysis module 120 may be integrated into a single unit or module. Such embodiments are advantageous when a consistent analysis is required and by embedding the analysis method into the analysis module 120, the likelihood of inconsistent results is reduced, since the reviewer 123 is unable to make any changes to the analysis being performed. It can also be appreciated that in some embodiments, a combination method may be used, in which limited customization, such as allowing an insertion of file name or selection of a test from a list can be provided.

In the various embodiments, the system 100 can also comprise a database interface module 130. As previously discussed, users typically access relational databases through a user interface, such as a scheduling module, but existing interfaces are generally only adapted for data entry use and simple queries. In order to properly perform an analysis of a project schedule 110, accessing desired project information using simple queries can be time consuming. The database interface module 130 allows the analysis module 120 to access the project schedule 110 without using a project scheduling application. By providing alternate access to the stored relational database, the database interface 130 allows the analysis module 120 to perform the basic query and file retrieval functions of database applications, but afterwards the analysis module 120 can use the available advanced functions to further manipulate, refine, and analyze the data according to an instruction set 122. Furthermore, using the instruction set 122, the process of query and retrieval can be completely automated, requiring minimal, if any, input or even any expertise or knowledge regarding access to the relational database on the part of the reviewer 123 that can be accessed via a terminal or user interface 121. It can be appreciated that in some embodiments, the interface module 130 and the analysis module 120 may be integrated by providing a database driver which allows the instruction set 122 or the analysis module 120 to access the relational database by making direct call to the database, using the driver to translate the calls and the data, allowing the data to be properly transferred to the analysis module. By way of example, not by way of limitation, in embodiments analyzing a project schedule 110 created using Microsoft Project™, the associated relation database could be accessed by the use of the ADO or ADOdb database drivers, which have been adapted to provide access to databases created by various Microsoft™ products. Similarly, other types of relational databases could be accessed using a similar and appropriate database driver.

In the various embodiments, it can be appreciated that the combined operation of the analysis module 120, the instruction set 122, and the database interface comprise a single analysis tool 140. Providing an analysis tool 140 including at least these three features allows a reviewer 123 to access and review a project schedule 110 without requiring any expertise in relational databases, or even the analysis process itself, by automating the project schedule 110 review process and reducing or eliminating interaction required on the part of a reviewer 123.

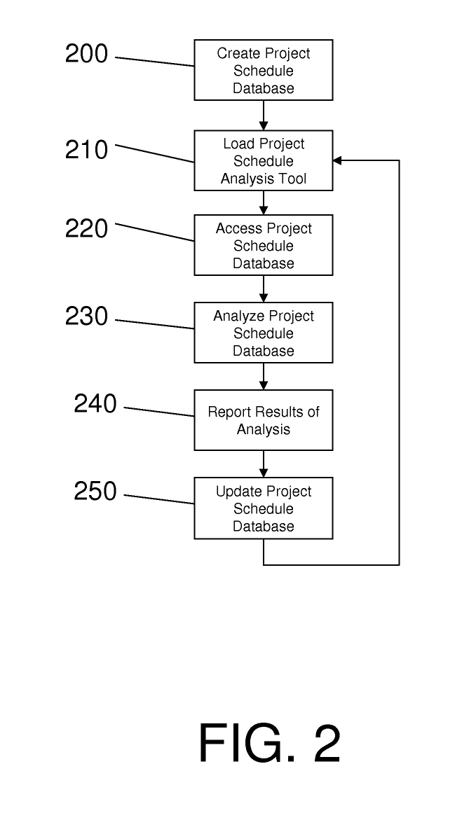

With reference to FIG. 2, a flow chart illustrates one method of analyzing the current status of a project in accordance with the present invention. Operationally, in Step 200, one or more users 112 would initially create a project schedule 110 using a scheduling tool, such as Microsoft Project™. In creating the project schedule, the user 112 would input a plurality of project activities, one or more requirements associated with each of the project activities, and one or more dependencies interrelating two or more project activities. In general, such scheduling tools provide for textual or graphical representation of the project schedule 110 to the user, which provide for easier comprehension, but store the project schedule 110 information as a relational database, which provides for efficient storage and access by a computing device, as previously discussed. Therefore, as the user 112 creates the project schedule 110 in step 200, the scheduling application automatically converts the entries into data structures to be stored on the mass storage system 111 and which comprise the entries of the various tables of the relational database representing the project schedule 110.

Once the project schedule 110 has been created, then it can be reviewed using an analysis tool 140. As shown in FIG. 2 at step 210, the reviewer 123 can load or initialize the analysis tool 140 which, as previously discussed, can comprise the analysis module 120. In some embodiments, initialization of the analysis tool may comprise of loading a software package, such as Microsoft Excel™, and loading a file comprising the instruction set 122 into the software package to instruct the software package how to perform the analysis of the project schedule 110. In other embodiments, this process may comprise opening or initializing a software package that is itself adapted to automatically begin the analysis. In such embodiments, the analysis module 120 and the instruction set 122 may be combined into a self-contained, executable analysis tool 140, requiring the reviewer 123 to only execute the analysis tool 140, which automatically performs the analysis of the project schedule 110 with minimal, if any, intervention required on the part of the reviewer 123.

Once the analysis tool 140 is initialized, the relational database representing the project schedule 110 is accessed and required data is retrieved, step 220. The analysis tool 140 then analyzes the data, according to the instruction set 122, using the analysis module 120, step 230, and reports the data to a user interface 121, step 240. In the various embodiments, the type of user interface used can vary. In some embodiments, the user interface can comprise the schedule analysis tool itself. For example, in embodiments where a spreadsheet is used, the results of the analysis can be reported as data imported into the current spreadsheet running the analysis, allowing the reviewer 123 to be able to simply forward the entire spreadsheet containing the analysis method and the results to one or more interested parties. In other embodiments, the results may be output to a separate results file which can also be reviewed or forwarded by the reviewer 123.

Since information in the relational database representing the project schedule 110 is not static, further review of the project schedule 110 will likely be necessary. In the various embodiments and as shown in the illustrated process flow in FIG. 2, a project schedule 110 may be updated at some later point in time by one or more users 112, step 250. After the project schedule 110 is updated, a reviewer 123 can begin the analysis process again by reloading the analysis tool, step 210, and allowing the tool to reanalyze the update project schedule 110, steps 220-240. In some embodiments, the recurring analysis could be automated. In such embodiments, an analysis tool could be further configured to review the project schedule 110 automatically, either on a predetermined time interval or after an update of one or more events in the project schedule 110. Furthermore, in some embodiments with a recurring analysis, the instruction set 122 in the analysis tool 140 could be further configured to automatically compare past and present results of the analysis as a part of the current analysis, further reducing the amount of expertise needed for a reviewer 123 to review and compare results generated.

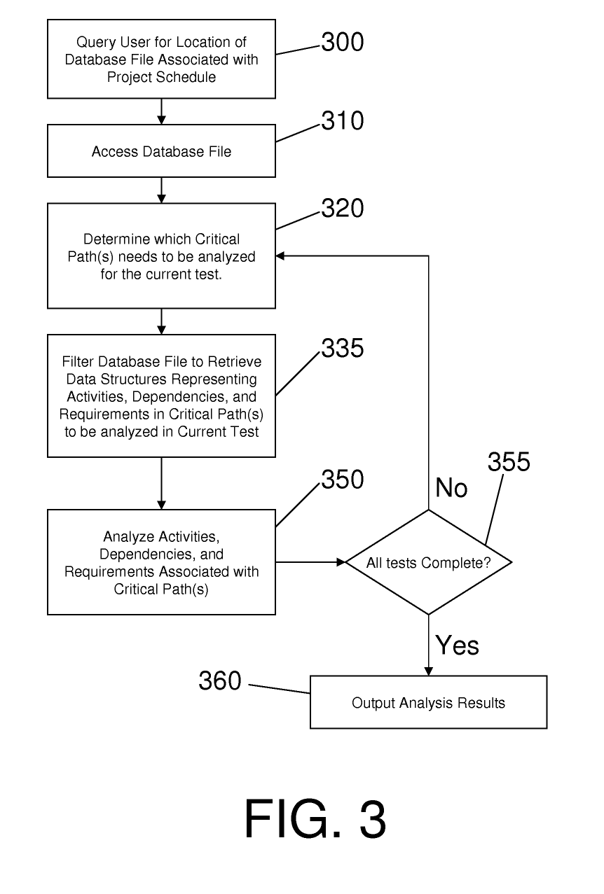

A more detailed view of the functioning of the analysis tool 140 is illustrated in the process flow shown in FIG. 3. An advantage of the present invention is the automation of the various tasks involved in an analysis of a single critical path, eliminating the need for expertise in manipulation of project schedule 110 data. For example, FIG. 3 illustrates an exemplary process flow for the analysis tool 140 when retrieving and manipulating data. First, the analysis tool 140 can query a reviewer 123 for a location of the relational database file representing the project schedule 110, step 300. In some embodiments, the query could comprise a dialog box or other query method initiated after the analysis tool 140 is loaded. In other embodiments, the query comprises simply a requirement on the reviewer 123 to provide the location of the database at time of loading of the analysis tool 140. An example of such an embodiment would be a command line interface for loading the analysis tool 140. Such methods of querying the reviewer 123 are provided only by way of example, not by way of limitation. In can be appreciated that other methods available for providing a file name could be used in the various embodiments.

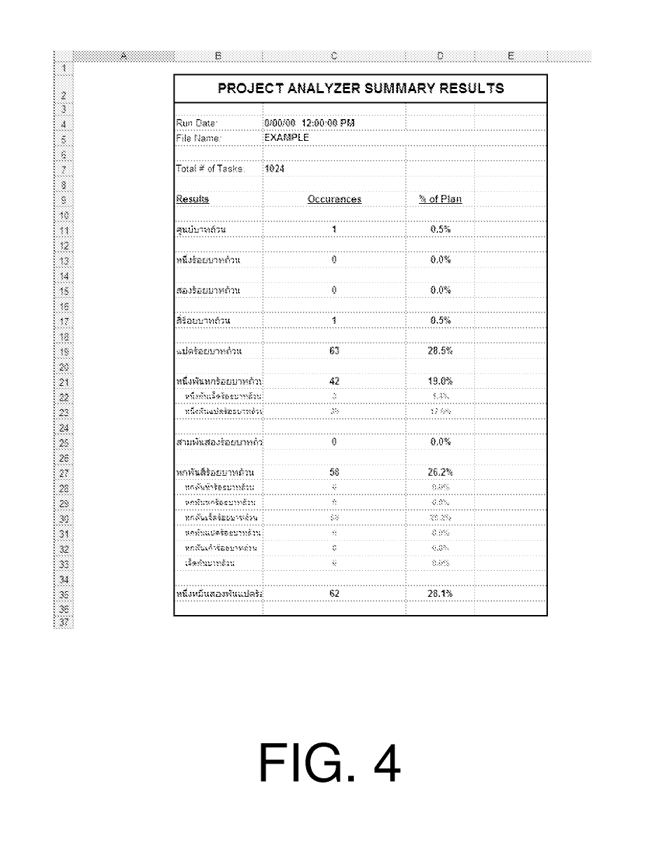

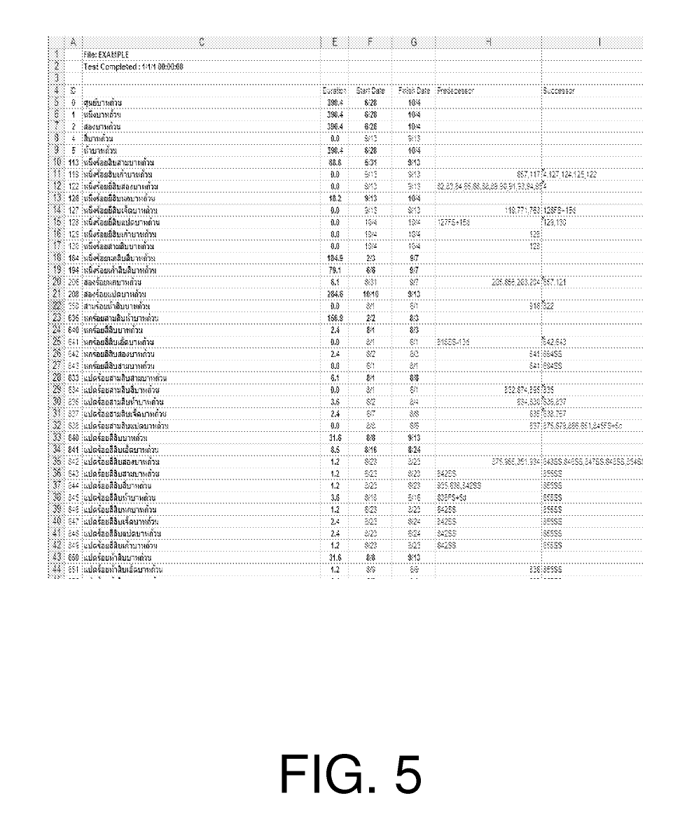

Next, the analysis tool 140 accesses and retrieves the data structures in relational database representing the project schedule 110, step 310, using the database interface 130 as previously discussed. Once access to the relational database is established, the analysis tool 140 needs to review the instruction set 122 and determine which critical paths and critical events need to be monitored and/or reviewed for a given test, step 320, so that the analysis tool 140 can determine how to manipulate the database data properly. After determining the needed data for a given test, the analysis tool 140 automatically filters the project schedule to recover only those data structures representing events, requirements, and dependencies necessary for the given analysis. step 335. Such filtering can be accomplished not only by queries to the relational database, but also through relational operations of the various tables of the relational database performed by the analysis module 120. Using only the filtered data, the analysis module 120 can perform the necessary calculations on the filtered data to calculate the results for a given test, step 350. Next, the analysis tool 140 determines if other tests need to be run, step 355. If other tests are still needed to be run, the steps of determining, filtering, and analyzing can be repeated by the analysis tool 140, steps 320-350. Once the final test is run, the analysis tool 140 reports the results of the analysis are output to a user interface 121 at step 360. In some embodiments, the output can be separate for each given test. In other embodiments, the output can comprise a summary or combined result of all the given tests. In other embodiments, both can be provided. In the illustrated embodiment as shown in FIGS. 4 and 5, the output comprises one or more spreadsheets, in which one spreadsheet can comprise summary information (FIG. 4), results of a given test (FIG. 5), or both. In the various embodiments, the use of a spreadsheet or other basic file type allows the reviewer 123 to easily view and share the results of the analysis of the project schedule 110. However, it can be appreciated in the various embodiments that other widely available file formats, such as text files, could be used to output the results to the reviewer.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A system for analyzing the current status of a project, the system comprising:
a project schedule comprising data structures representing activity information associated with a plurality of project activities stored in a relational database, wherein the activity information comprises one or more requirements associated with each one of the plurality of project activities and one or more dependencies interrelating at least two of the plurality of project activities;
a database interface configured to allow access to at least a portion of the data structures stored in the relational database;
an analyzer configured to perform an analysis of one or more selected critical paths, wherein the one or more selected critical paths comprises a critical path selected according to one or more criteria, wherein a series of interrelated project activities terminating with a critical activity define a critical path;
whereby the analyzer accesses the relational database using the database interface, searches the relational database for one or more data structures associated with the one or more selected critical paths, retrieves the one or more data structures associated with the one or more selected critical paths, analyzes the one or more one data structures associated with the one or more selected critical paths, and outputs a result of the analysis to a user interface.

2. The system of claim 1, wherein the analysis is further comprised of one or more subtests, wherein each of the one or more subtests is configured to produce a subtest result.

3. The system of claim 2, wherein a subtest of the one or more subtests is configured to evaluate one selected critical path of the one or more selected critical paths.

4. The system of claim 2, wherein a subtest result is output to a user interface.

5. The system of claim 2, wherein a combined summary of a subtest result of each of the one or more subtests is output to the user interface.

6. The system of claim 2, wherein at least one of the one or more subtests comprises a standardized project status test.

7. A method for analyzing the current status of a project, the method comprising:
locating a project schedule comprising data structures representing activity information associated with a plurality of project activities stored in a relational database, wherein the activity information comprises one or more requirements associated with each one of the plurality of project activities and one or more dependencies interrelating at least two of the plurality of project activities;
accessing the relational database using a database interface, the database interface being configured to allow access to at least a portion of the data structures stored in the relational database;
searching the relational database for one or more data structures associated with one or more selected critical paths; wherein each one of the one or more selected critical paths comprises a critical path selected according to one or more criteria, wherein a series of interrelated project activities terminating with a critical activity defines a critical path;
retrieving the one or more one data structures associated with the one or more selected critical paths;
analyzing the one or more one data structures associated with the one or more selected critical paths; and
outputting results of the analysis of the one or more data structures to a user interface.

8. The method of claim 7, the analyzing step further comprising:
executing one or more subtests, wherein each one of the one or more subtests being configured to produce a subtest result.

9. The method of claim 8, wherein a substest of the plurality of subtests is configured to evaluate a selected critical path of the one or more selected critical paths.

10. The method of claim 8, wherein the subtest result is output to a user interface.

11. The method of claim 8, wherein a combined summary of the result of each one of the plurality of the subtests is output to a user interface.

12. The method of claim 8, wherein at least one of the one or more subtests comprises a standardized project status test.

13. A machine readable storage, having stored thereon a computer program having a plurality of code sections executable by a machine for causing the machine to perform the steps of:
storing a relational database, the relational database storing data structures representing activity information associated with a plurality of project activities, wherein the activity information comprises one or more requirements associated with each one of the plurality of project activities and one or more dependencies interrelating at least two of the plurality of project activities;
retrieving a project status instruction set, the project status instruction set comprising instructions for an analysis of one or more selected critical paths, wherein each one of the one or more selected critical paths comprises a critical path selected according to one or more criteria defined in the project status instruction set, wherein a series of interrelated project activities terminating with a critical activity defines a critical path;
accessing the relational database using a database driver, the database driver being configured to provide access to the data structures stored in the relational database;
searching the relational database for one or more data structures associated with the one or more selected critical paths;
retrieving the one or more one data structures associated with the one or more selected critical paths;
analyzing the one or more one data structures associated with the one or more selected critical paths according to the project status instruction set; and
outputting a result of the analysis of the one or more one data structures associated with the one or more selected critical paths to a user interface.

14. The machine readable storage of claim 13, wherein the instructions in the project status instruction set further comprise of one or more subtests, wherein each one of the one or more subtests is configured to produce a subtest result.

15. The machine readable storage of claim 14, wherein a subtest of the one or more subtests is configured to evaluate one of the one or more selected critical paths.

16. The machine readable storage of claim 14, wherein a subtest result is output to the user interface.

17. The machine readable storage of claim 14, wherein a combined summary of the subtest result of each one of the one or more subtests is output to the user interface.

18. The machine readable storage of claim 14, wherein at least one of the one or more subtests comprises a standardized project status test.
